(19) United States
(12) Patent Application Publication
(10) Pub. No.: US 2003/0181194 A1
(43) Pub. Date: Sep. 25, 2003

(54) Signaling information compression

(75) Inventors: Oleg Litvak, Ariel (IL); Yair Hevdeli, Hod Hasharon (IL)

Correspondence Address: BROWDY AND NEIMARK, P.L.L.C., 624 NINTH STREET, NW, SUITE 300, WASHINGTON, DC, 20001-5303, US

(73) Assignee: ECI Telecom Ltd., Petach Tikva (IL)

(21) Appl. No.: 10/368,010

(22) Filed: Feb. 19, 2003

Related U.S. Application Data
(63) Continuation of application No. PCT/IL01/00755, filed on Aug. 14, 2001.

(30) Foreign Application Priority Data
Aug. 15, 2000 (IL) 137864

(51) Int. Cl. H04Q 7/20

(52) U.S. Cl. 455/403; 455/405

(57) ABSTRACT

A method for compression of signaling information in a telecommunication network, the method comprising the steps of a) providing a transmission link for transmitting a transmission including signaling information from a transmitting end of the transmission to its receiving end, b) at the transmitting end, suppressing the transmission of at least some of the signaling information in accordance with a prevailing compression scheme; and c) at the receiving end, regenerating the signaling information suppressed at the transmitting end.

### FIELD OF THE INVENTION

The invention is in the field of telecommunications.

### BACKGROUND OF THE INVENTION

Common Channel Signaling (hereinafter referred to as “CCS”), for example Signaling System #7 (hereinafter referred to as “SS7”) consolidates all signaling information in respect of traffic along one or more traffic channels along one or more signaling channels. In particular, SS7 employs three types of Signal Units (SUs) as follows: First, Message Signal Units (MSUs) for all call set-up and teardown, billing, routing, and information-exchange purposes. Second, Link Status Signal Units (LSSUs) for communicating information between the network elements at the ends of an in-service signaling link. And third, Fill-in Signal Units (FISUs) for facilitating the continuous monitor of an in-service signaling link and the acknowledgement of other SUs in the absence of MSUs or LSSUs and, in the main as their name suggests, for padding purposes.

### SUMMARY OF THE INVENTION

In accordance with the present invention, there is provided a method for signaling information compression in a telecommunication network, the method comprising the steps of:

(a) providing a transmission link for transmitting a mission including signaling information from a transmitting end of the transmission to its receiving end;

(b) at the transmitting end, suppressing the transmission of at least some of the signaling information in accordance with a prevailing compression scheme; and

(c) at the receiving end, regenerating the signaling information suppressed at the transmitting end.

The present invention is based on the notion that a telecommunication network may generate CCS signaling information which can be compressed along an actual transmission link in a transparent manner, thereby freeing up hitherto allocated bandwidth along the transmission link for revenue generating traffic. It is envisioned that the signaling information to be compressed i.e. initially suppressed and thereafter regenerated, is more network related as opposed to subscriber related in the sense that it is not a direct consequence of subscribers' actions, for example, call set-up, call teardown, and the like. Thus, the signaling information to be suppressed and regenerated can include at the very least non-essential signaling information provided for padding purposes only, for example, subsequently identical FISUs after one or more and preferably three immediately preceding identical FISUs in the SS7's FISU Continuous Mode of Operation, continuous streams of HDLC flags in the SS7's FISU Cyclic Mode of Operation, and the like.

The present invention can be readily implemented in a wide range of telecommunication infrastructures as follows: First, along so-called thin route or very in route transmission links where the present invention may possibly make hitherto uneconomical transmission links profitable. Second, as a supplement to Digital Circuit Multiplication Equipment (DCME), thereby enhancing their gains particularly in the case of thin route and very thin route transmission links. Third, within a so-called carrier-of-carriers telecommunication network, thereby at least partially negating the hitherto practice of providing clear channels for each carrier's signaling information. And fourth, at data network packet gateways to ATM clouds, Frame Relay clouds, IP clouds, and the like.

### BRIEF DESCRIPTION OF THE DRAWINGS

In order to understand the invention and to see how it can be carried out in practice, preferred embodiments will now be described, by way of non-limiting examples only, with reference to the accompanying drawings, in which similar parts are likewise numbered, and in which:

FIG. 1 is a schematic representation of a thin route transmission link constructed and operative in accordance with the present invention;

FIG. 2 is a schematic representation of an SS7 Message Signal Unit (MSU) in a left-to-right order of transmission;

FIG. 3 is a schematic representation of an SS7 Link Status Signal Unit (LSSU) in a left-to-right order of transmission;

FIG. 4 is a schematic representation of an SS7 Fill-in Signal Unit (FISU) in a left-to-right order of transmission;

FIG. 5 is a flow diagram of an FISU suppression algorithm operative at a transmitting end of the transmission link of FIG. 1;

FIG. 6 is a flow diagram of an FISU regeneration algorithm operative at a receiving end of the transmission link of FIG. 1;

FIG. 7 is a schematic representation of an exemplary nine DCME frame long transmission without signaling information compression from PSTN Class 4/5 switch A to PSTN Class 4/5 switch B in FIG. 1;

FIG. 8 is a schematic representation of the transmission of FIG. 7 subsequent to the FISU suppression scheme of FIG. 5;

FIG. 9 is a schematic representation of the transmission of FIG. 8 subsequent to the FISU regeneration scheme of FIG. 6;

FIG. 10 is a schematic representation of another type of telecommunication network constructed operative in accordance with the present invention; and

FIG. 11 is a schematic representation of another type of telecommunication network constructed and operative in accordance with the present invention.

### DETAILED DESCRIPTION OF THE DRAWINGS

FIG. 1 shows a thin route transmission link 1 for carrying a transmission including voice, fax and data traffic and SS7 signaling information to/from an PSTN Class 4/5 switch A and to/from an PSTN Class 4/5 switch B. The voice, fax and data traffic is compressed along the transmission link 1 by way of a pair of Digital Circuit Multiplication Equipment (DCME) network elements 2A and 2B such as the DTX-600 Network Optimizer™ commercially available from the proprietor of the present invention. The DTX-600 Network Optimizer supports a dynamic bandwidth allocation algorithm illustrated and described in commonly owned GB 2,339,507, and also as published in a White Paper entitled “The Springs Technology, a Springboard to the Convergence of Toll Quality and Data” by Sason Sourani presented in ECI Telecom Annual Technical & Planning Symposium, Toronto, Canada, Jul. 12-16, 1999.

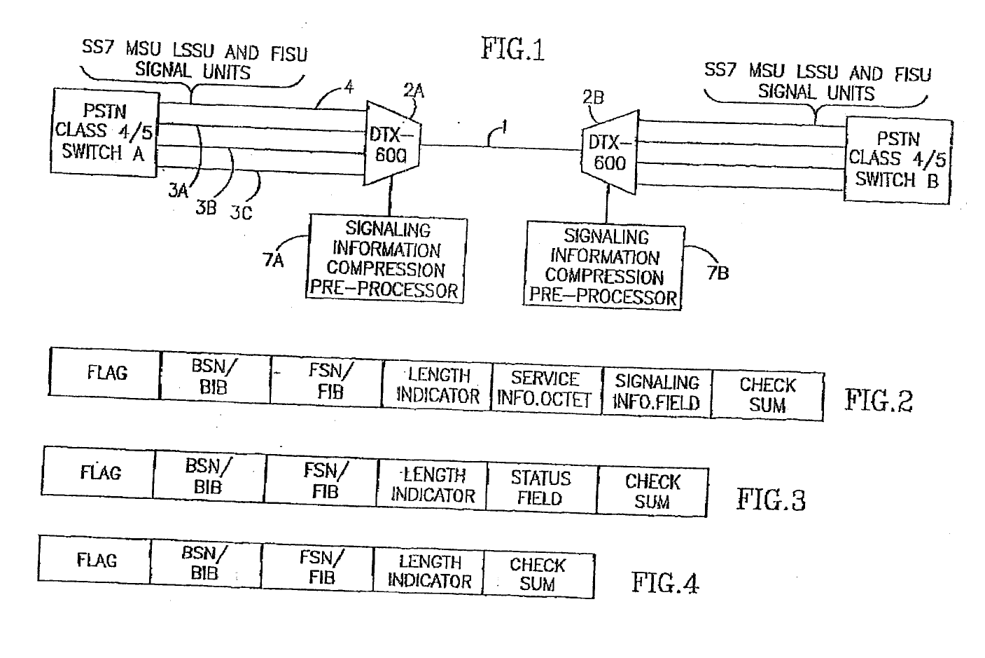

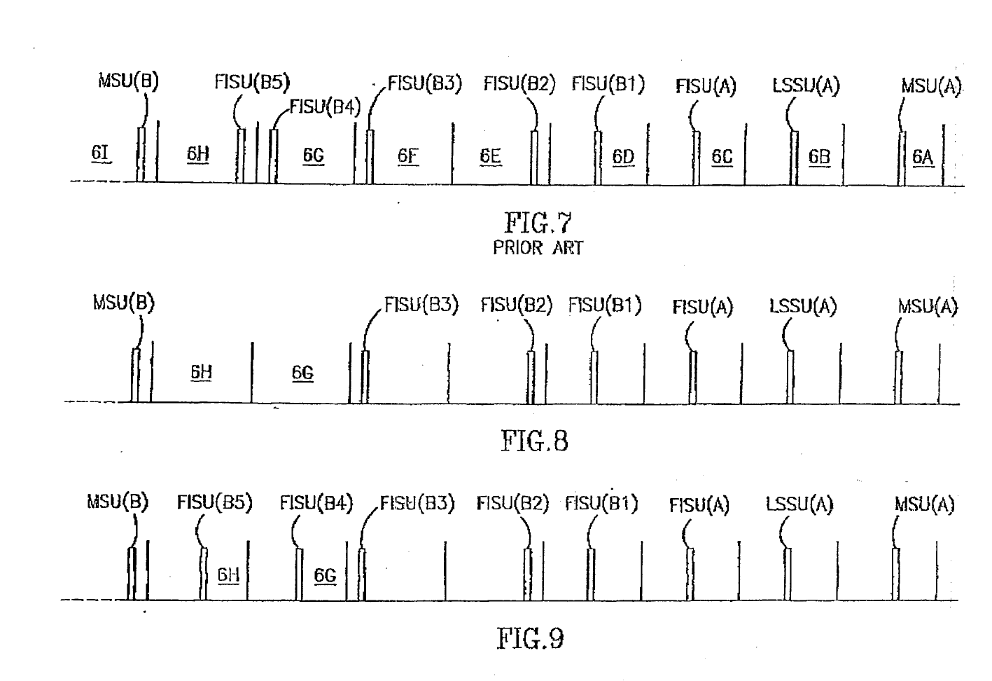

The SS7 signaling information for all the voice, ax and data traffic transported along three traffic channels 3A, 3B and 3C between the switches A and B is transported along a 64 kbps common signaling channel 4. The SS7 signaling information consists of MSUs (see FIG. 2), LSSUs (see FIG. 3), and FISUs (see FIG. 4) which each include a Length Indicator (LI) whose field value depends on the signal unit type as follows: an MSU has an LI field value >2, an LSSU has an LI field value equal to one or two, and an FISU has an LI field value equal to zero. The DCME network elements 2 dynamically allocate a clear channel time slot per DCME frame 6 for transporting an SS7 SU be it an MSU, an LSSU, or n FISU (see FIG. 7).

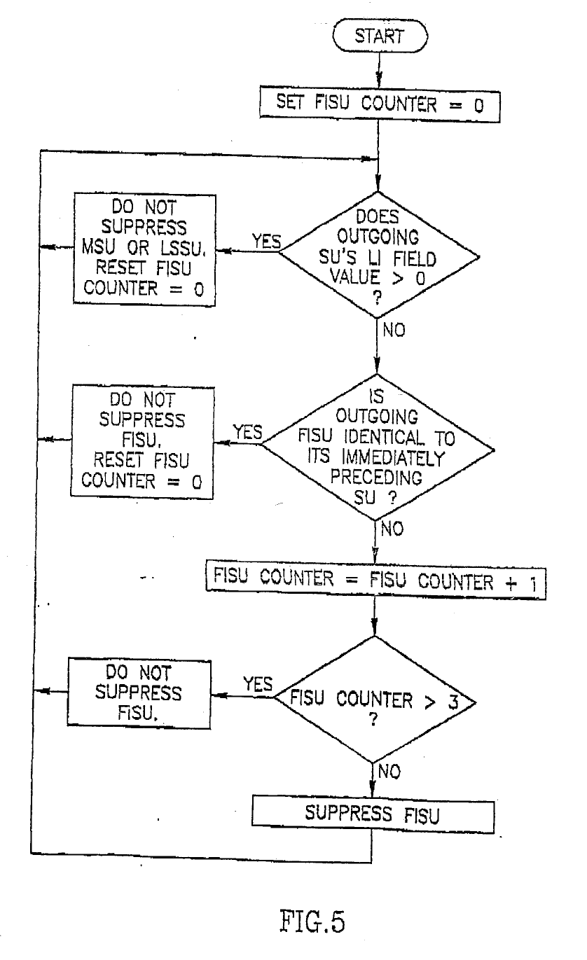

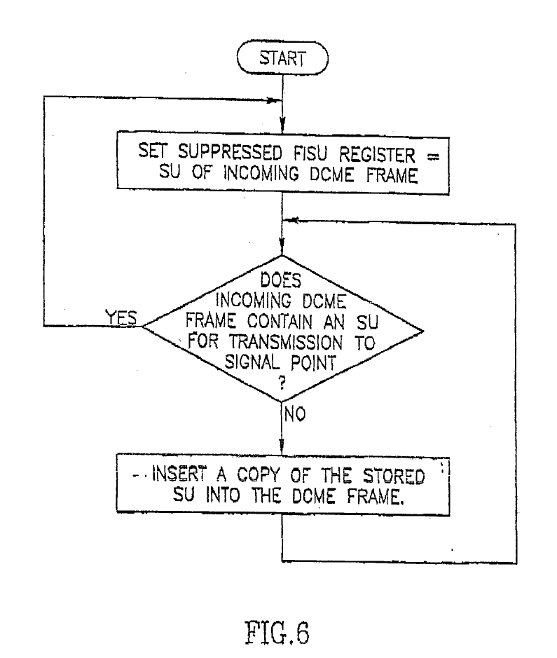

The DCME network elements 2 each include a signaling information compression pre-processor 7 for signaling information Compression along the transmission link 1 in accordance with a prevailing compression scheme specifying, for example, that all SUs be transported for transmission to a signal point except for FISUs which are identical to three immediately preceding FISUs since it is reasonably safe to assume that such FISUs are generated for merely padding purposes. The suppression of such FISUs at the transmitting end of a transmission along the transmission link 1 can be effected by an FISU suppression algorithm capable of distinguishing between FISUs and the other two types of SS7 SUs on the basis of an SU's LI field value (see FIG. 5). The regeneration of the FISUs suppressed at the transmitting end of a transmission at its receiving end can be effected by an FISU regeneration algorithm capable of detecting DCME frames missing an SU by their lack of an HDLC flag 01111110 (see FIG. 6).

The operation of the FISU suppression algorithm and the FISU regeneration algorithm are now described with respect to the nine DCME frame long transmission without signaling information compression shown in FIG. 7. The nine DCME frames 6A-6I each include an SS7 SU as follows: MSU(A), LSSU(A), FISU(A), five identical an consecutive FISUs numbered FISU(B1), FISU(B2), FISU(B3), FI(B4) and FISU(B5), and lastly MSU(B). The FISU suppression algorithm suppresses the fourth and fifth identical FISUs, namely, FISU(B4) and FISU(B5) in the DCME frames 60 and 6H, thereby enabling the DCME network element 2A to insert additional voice, fax, or data traffic in those frames in comparison to the same DCME frames originally including the FISU(B4) and FISU(B5) SUs (see FIG. 8). The FISU regeneration algorithm regenerates the FISU(B4) and FISU(B5) SUs in the DCME frames 6G and 6H; albeit in different locations than the original FISU(B4) and FISU(B5) SUs which is of no consequence in terms of the actual signaling information, whereby the signaling information compression of the transmission is fully transparent at its receiving end (see FIG. 9).

Simulations have shown that in the case of transmission links carrying Toll Quality voice traffic only, the above described signaling information compression can render overall compression gain of over 40% in the case of a 2×64 kpbs thin route transmission link and support the carrying of 15 simultaneous Toll Quality voice calls over 1×64 kpbs very tin route transmission link which would otherwise not be economically viable without signaling information compression.

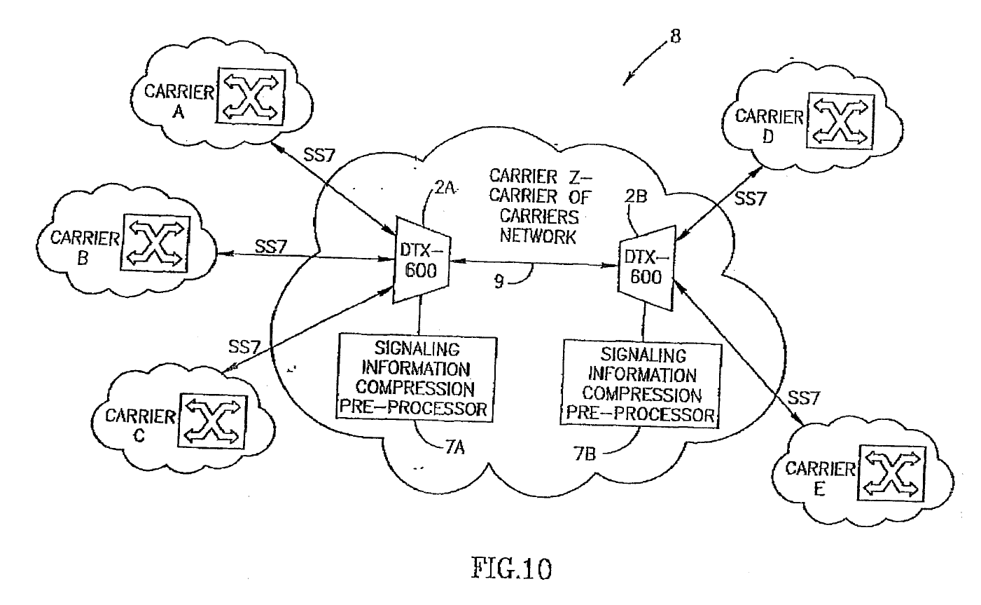

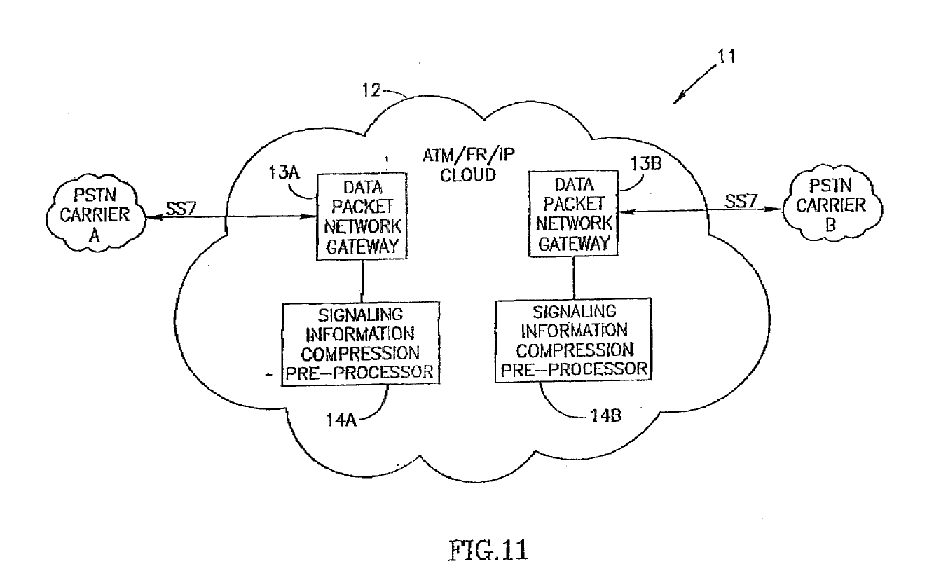

FIG. 10 shows a carrier-of-carriers telecommunication network 8 including a transmission link 9 for transporting voice, fax and data traffic to/from carriers A, B and C and to/from carriers and E, and DCME network elements 2A and 2B with signaling information compression pre-processors 7A and 7B for reducing the signaling information overhead over the transmission link 9. In the case that carrier Z employs a single 2.048 Mbps bearer, and the carriers A, B and C have the same traffic load of 90% Toll Quality voice calls and 10% fax calls, then the carrier Z can carry a total of 480 calls (80 calls for each one of the routes A-D, B-D, C-D, A-E, B-E and C-E) with the signaling information compression of the present invention as opposed to 384 calls (64 calls for each one of the above routes) thereby facilitating the transport of 31% more revenue generating traffic.

FIG. 11 shows a telecommunication network 11 including a ATM/FR/IP cloud 12 (constituting a transmission link) for transporting voice, fax, and data traffic to/from PSTN carrier A and to/from PSTN carrier B, and data packet network gateways 13A and 13B with signaling information compression pre-processors 14A and 143 for reducing the signaling information overhead through the ATM/FR/IP cloud 12.

While the invention bas been described with respect to a limited number of embodiments, it will be appreciated that many variations, modifications, and other applications of the invention can be made within the scope of the appended clams. For example, the present invention can be equally applied to other CCS signaling schemes including inter alia earlier versions of Signaling System 7, and the like.

1. A method for signaling information compression in a telecommunication network, the method comprising the steps of,
(a) providing a transmission link for transmitting a transmission including signaling information firm a transmitting end of the transmission to its receiving end;
(b) at the transmitting end, suppressing the transmission of at least some of the signaling information in accordance with a prevailing compression scheme; and
(c) at the receiving cad, regenerating the signaling information suppressed at the transmitting end.

2. The method according to claim 1 wherein the compression scheme specifies suppression of a portion of the signaling information having a predetermined length which repeats at least one immediately preceding portion of the signaling information having the same length.

3. The method according to claim 2 wherein the compression scheme specifies suppression of an FISU on the condition that it is identical to its at least one immediately preceding FISU in the SS7's FISU Continuous Mode of Operation.

4. The method according to claim 3 wherein the compression scheme specifies suppression of an FISU on the condition that it is identical to its three immediately preceding FISUs in the SS7's FISU Continuous Mode of Operation.

5. The method according to claim 2 wherein the compression scheme specifies suppression of an HDLC flag on the condition that it immediately follows an HDLC flag in the SS7's FISU Cyclic Mode of Operation.

6. A processor capable of executing the method according to any one of claims 1 to 5.

7. A DCME network element including a processor according to claim 6.

8. A data packet network gateway including a processor according to claim 6.

9. A transmission link capable of executing the method according to any one of claims 1 to 5.

10. The link according to claim 9 wherein the transmission link is a thin route transmission link.

11. The according to claim 9 wherein the transmission link is a very thin route transmission link.

12. The link according to any one of claims 9 to 11 wherein the transmission link transports DCME compressed voice, fax and data traffic.

13. The link according to claim 9 wherein the transmission link brides between two carriers in a carrier-of-carriers telecommunication network.

14. The link according to claim 9 wherein the transmission link is an ATM/FR/IP cloud.
